(19) United States
(12) Patent Application Publication
(10) Pub. No.: US 2015/0020153 A1
(43) Pub. Date: Jan. 15, 2015

(54) COLLABORATIVE MEDIA PRESENTATION SERVICE WITH USAGE RIGHTS ENFORCEMENT

(71) Applicant: MYSPACE MUSIC LLC, Beverly Hills, CA (US)

(72) Inventors: Steven S. Jang, San Francisco, CA (US); Dalton M. Caldwell, Mountain View, CA (US); Jan F. Jannink, Menlo Park, CA (US)

(73) Assignee: MYSPACE MUSIC LLC, Beverly Hills, CA (US)

(21) Appl. No.: 14/502,759

(22) Filed: Sep. 30, 2014

Related U.S. Application Data
(63) Continuation of application No. 11/521,763, filed on Sep. 15, 2006, now abandoned.

(51) Int. Cl. H04L 29/06; G06F 21/62

(52) U.S. Cl. CPC H04L 63/0876; G06F 21/6272; H04L 2463/101; G06F 2221/2115
USPC 726/1

(57) ABSTRACT

An online collaborative media presentation service is provided. Users of the online service can create highly customized profiles that contain personal profile information and information on media files and other topics of interest. Users can upload media files to a media server associated with the online service without preapproval from content owners. The rights of content owners are preserved by using a digital rights management service to identify uploaded media files. The media server submits uploaded media files to the digital rights management service to determine whether streaming of the media files is permissible. If streaming is not permitted, the media server can block an uploaded file. If streaming is permitted, the media server can make the media file available for streaming. When streaming media to users, the media server displays targeted advertisements and other related content to users. The related content adds value for the online service.

### CROSS-REFERENCE TO RELATED APPLICATIONS

This application is a continuation under 35 U.S.C. §120 of application Ser. No. 11/521,763 (corresponding to Attorney Docket No.: 257.46-US-01), filed on Sep. 15, 2006, by Steve S. Jang, Dalton M. Caldwell, and Jan F. Jannink, entitled “COLLABORATIVE MEDIA PRESENTATION SERVICE WITH USAGE RIGHTS ENFORCEMENT,” which application is incorporated by reference herein.

### BACKGROUND OF THE INVENTION

The present invention relates to web-based communications services, and more particularly, to services that allow users to communicate with each other about songs and other media while respecting media usage rights.

Peer-to-peer and server-based online communities exist in which users can interact and share media. For example, peer-to-peer networks allow users to swap songs and other files. Server-based online forums allow users to create posts. Some server-based online communities also allow users to attach files to posts, which other users can download.

In online communities such as these, it can be difficult or impossible to ensure that media usage rights are not violated. For example, if a forum allows users to attach music files to community messages, it can be difficult or impossible to prevent users from sharing copyrighted material without the permission of the copyright owner.

What is therefore needed is an online community that allows users to communicate about shared interests in media while ensuring that the usage rights of media owners are respected.

### SUMMARY OF THE INVENTION

An online service that allows users to communicate about shared interests in media while respecting the rights of media owners is provided.

Users at personal computers or other user computing equipment can upload media files such as songs to a media server over a communications network such as the internet. The media server submits uploaded files to a digital rights management service to determine whether content owners will permit the uploaded files to be streamed to users over the internet. If it is permissible to stream the uploaded files to users, the media server makes the uploaded files visible to users and allows users to play the uploaded files in their media players.

The service allows users to form dynamic online communities around shared interests in songs or other media. Users can create highly customized online profiles with multiple sub-profiles to provide forums to communicate about various topics of interest. Uploading users need not have any relationship with content owners to submit media files to the media server. Even though uploading users do not need to communicate with content owners or come to any particular agreement with content owners regarding usage of the media files, the rights of the content owners are respected. This is because the media server will not make the uploaded media files available for streaming to users when streaming is prohibited by media usage rules that have been established by the content owners.

While media is being streamed to a user, the online service can present related content such as targeted advertisements. The targeted advertisements can be used to generate revenue for the online service.

Because the rights of content owners are respected without requiring users to become actively involved in usage rights management issues, users can freely customize their online profiles by uploading a wide variety of media. This allows for the creation of vibrant online communities. The use of digital rights management ensures that the rights of content owners are respected. A content owner can set usage rights limits as deemed necessary and can even modify the usage rights associated with a media file after the media file has been released. The presentation of related content to users helps to add value for the online service. The interests of both users and the content owners are furthered as the online service thrives.

When the digital rights management service receives an uploaded file from the media server, the digital rights management service uses a media file fingerprint checking engine to produce a media file fingerprint for the uploaded file. The media file fingerprint and other data associated with the uploaded file can be compared to a registry maintained by the digital rights management service to identify the media file and to determine which usage rules apply to the media file. If desired, the usage rules may be geographically sensitive. With a geographically sensitive arrangement, different usage rights limitations will apply to users whose equipment is located in or otherwise associated with different countries, states, or other geographic entities. Members (e.g., members with certain types of online service subscriptions) may also be given different access to media files than non-members.

If the media file does not match any listed media files in the registry, the online service may assume that the media file is unrestricted. If the media file matches a listed media file in the registry, the digital rights management service can look up which usage rules apply to the media file and can provide this information to the media server. The media server presents the media file to users in accordance with the usage rules. For example, if the usage rules permit real-time streaming of the media file to users over the internet, the media server can stream the media file to media players running on the users' computing equipment.

An uploading user and other users can associate metadata tags with uploaded media files. For example, a user can add a tag “L.A.” to a song that relates to the city of Los Angeles. The metadata tags of the uploading user and the metadata tags of other users can be added to original metadata tags that accompany certain media files. When the media file is being streamed to a user, related content such as a targeted advertisement may be presented to the user. If desired, the related content can be displayed just before or just after the media file is streamed to the user. For example, the related content may be a video advertisement that is streamed to the user just before the media file is streamed to the user or that is streamed to the user just after the media file has been streamed to the user. The related content can be identified based on the original metadata tags and the metadata tags supplied by users.

Further features of the invention, its nature and various advantages will be more apparent from the accompanying drawings and the following detailed description.

### BRIEF DESCRIPTION OF THE DRAWINGS

FIG. 1 is a diagram of an illustrative system that may be used to support an online service in which members at computing equipment can share media with each other while usage rights are enforced in accordance with the present invention.

FIG. 2 is a diagram showing screens that may be presented to a user when a user logs into an online community and uploads media files in accordance with the present invention.

FIG. 3 shows an illustrative personal profile screen that an online service may present to a user that includes a media player that is presenting a media file to the user, interactive options, tags and other metadata, and related content in accordance with the present invention.

FIG. 4 shows an illustrative community profile screen that an online service may present to users of the service in accordance with the present invention.

FIG. 5 shows an illustrative screen that may be presented to users by an online service to provide the users with an opportunity to add metadata to a media file in accordance with the present invention.

FIG. 6 is a flow chart of illustrative steps involved in using an online service in which media is shared while usage rights are enforced in accordance with the present invention.

FIG. 7 is a flow chart of illustrative steps involved as a user of an online service locates media content of interest and adds metadata to the content in accordance with the present invention.

FIG. 8 is a flow chart of illustrative steps involved in using an online service to present a user of the service with a media file and related content while preserving usage rights associated with the media file in accordance with the present invention.

FIG. 9 is a flow chart of illustrative steps involved when a user edits online profile information at an online service and when the online service provides users with related content based on media file metadata and profile information in accordance with the present invention.

FIG. 10 is a flow chart of illustrative steps involved when a content owner establishes and updates usage rights information associated with a media file in accordance with the present invention.

### DETAILED DESCRIPTION OF THE PREFERRED EMBODIMENTS

The present invention relates to a service that allows users to share content and communicate with each other about topics of mutual interest. The service of the present invention can be based on any suitable architecture such as a peer-to-peer network architecture, a server-based architecture, arrangements involving both peer-to-peer and server-based elements, etc. For illustration, features of the present invention are sometimes described in the context of a server-based architecture. This is, however, merely illustrative. The features of the present invention apply to any suitable online service in which users can share content and communicate.

Services that allow users to develop online relationships and to participate in online communications are sometimes referred to as social networking services. The systems and methods of the present invention may be used to support the operation of a social networking service or any other type of online service involving communications between a group of users. In some situations, users of an online service may be subscribers who are able to log into the service. Users who log into a service are sometimes referred to as being members of the service.

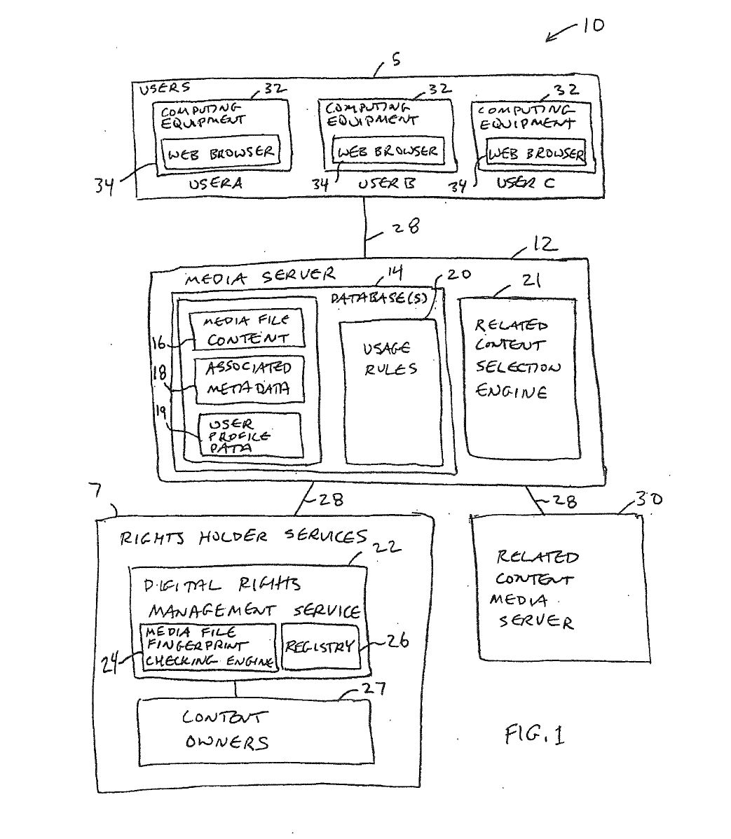

An illustrative system 10 that may be used to support an online collaborative media presentation service in accordance with the present invention is shown in FIG. 1. The online service allows users 5 to communicate with each other about songs and other media of mutual interest. Media server 12 stores user profile data 19 for users 5. In a typical scenario, a user creates a personal profile in the online service. The personal profile may contain personal profile information such as media file descriptions, blog entries, cover art, links to favorite web sites, etc. The personal profile may also contain sub-profiles for various topics (e.g., a particular recording artist). Sub-profiles can contain streamable media files, media file descriptions, blog entries, cover art, links to favorite web sites, etc.

The online service provides a rich environment for users to communicate with each other while contributing to profiles of interest. Users can upload media files freely, because media server 12 only streams media files to users if not prohibited by usage rules. By using profile editing functions associated with the online service, users can contribute content of interest to other users and can critique the contributions of other users.

Content owners benefit from the online service because the online service provides a rich platform from which content owners can promote their media. As an example, a recording artist can create a profile to promote the artist's music. As another example, a record label can create a profile to promote a number of the record label's popular bands. Content owners can promote media without concern that their usage rights will be violated, because usage rights are enforced by the online service before users are provided with media access.

The online service can present targeted advertisements and other such content to users. This type of content adds value for the online service and can generate revenues. Because the online service is supported in this way, the online service is able to make various collaborative features available to users and is able to make media promotion opportunities available to rights holders. The online service therefore helps to further the interests of all involved parties.

The online service may use a media server 12. Media server 12 facilitates interactions between users 5 and rights holder services 7 to ensure that the media usage rights of artists and other content owners 27 are satisfied. Media server 12 can stream media files to users 5 over the internet. While media is being presented to users, media server 12 can use related content media server 30 to display targeted advertisements and other related content to the users.

If desired, the related content can be displayed just before or just after the media file is streamed to the user. With one suitable arrangement, the related content is presented in the form of a streamed targeted video advertisement or still images that are presented to the user before the user is presented with the media file. This approach forces the user to view the related content before obtaining access to the media file. With another suitable arrangement, the related content is presented to the user just after the media file has been presented. Because the user's attention will be focused on the service, the user will tend to view the related content (e.g., a targeted advertisement). Related content that is displayed at the same time as the media file is typically presented in the form of textual or graphical material, so as not to interfere with video and/or audio material in the media file. Related content that is displayed before the media file is played or following media file playback may be textual or graphical material or may include audio (e.g., in a video or accompanying graphics), because interference between the media file and the related content is less likely when these materials are displayed in sequence rather than simultaneously.

Users such as users A, B, and C in FIG. 1 have associated computing equipment 32 on which client software such as web browsers 34 may be implemented. Computing equipment 32 may include personal computers, workstations, mainframe computers, handheld computing devices, cellular telephones, laptop computers, or any other suitable computing equipment.

Computing equipment 32 and the web browser 34 or other client software implemented on the computing equipment 32 may be used to communicate over a communications network, shown schematically by communications network paths 28. Communications network 28 may include local area networks (LANs), wide area networks (WANs), wired networks, wireless networks, etc. In a typical scenario, communications network 28 includes the internet.

Rights holder services 7 include content owners 27 who control the rights in media such as songs, videos, text, and images and a digital rights management service 22 for enforcing the rights of content owners 27. Content owners 27 provide usage rights information to digital rights management service 22, which digital rights management service stores in registry 26. Content owners 27 can update the usage rights information as needs change over time (e.g., when it is desired to relax usage rights restrictions to promote a particular song, etc.).

System 10 may include related content media server 30 for use in presenting targeted advertisements and other content that is related to the media and profile content being viewed by users. Equipment in system 10 such as computing equipment 32, media server 12, equipment for supporting rights holder services 7, and related content media server 30 can communicate over communications network 28.

Media server 12 may be used to store media file content 16 such as songs or other audio files, videos, images, documents, etc. Songs and other media files typically have associated metadata 18 (e.g., artist name, genre, etc.). Some of the metadata 18 originates with the song or other media file, whereas other metadata is added by an uploading user or other users. Media file content 16 and metadata 18 may be stored in one or more databases 14.

Media server 12 may consult digital rights management service 22 over network 28 to determine which usage rights are associated with a particular media file. Media server 12 may present media to users at computing equipment 32 over network 28 (e.g., as streaming audio or video) in accordance with usage rules 20 that are stored in database 12. If desired, targeted advertisements or other suitable related content may also be presented to users over network 28 (e.g., using related content media server 30). Related content selection engine 21 may be used by media server 12 in determining which related content from media server 30 is to be presented to users.

The equipment associated with users 5, rights holder services 7, and servers 12 and 30 may be implemented using any suitable computing equipment. With one illustrative arrangement, the equipment associated with servers 12 and 30, digital rights management services 22, and content owners 27 is implemented using one or more servers. Each server may be implemented on one or more hardware platforms. For example, one server may be implemented using one or more computers. If desired, multiple servers may be implemented on the same computer. Moreover, the functions of the various services shown in system 10 may be provided using different arrangement in which, for example, multiple services are combined into a single service or a single service is divided into multiple services. As one example, the functions of digital rights management service 22 may be implemented using the same server that is used to implement the functions of media server 12. As another example, the functions of digital rights management service 22 may be implemented using the same server that is used to implement the functions of content owner services 27.

Media server 12 or other suitable equipment in system 10 (e.g., an authentication server) may be used to maintain user account information for the online service. In a typical scenario, user credentials may be stored in the form of a username and password. If desired, other user credentials may be stored (e.g., biometric credentials). User settings may also be maintained. Privacy settings can be maintained by the service that are used to control which content is accessible to each member of the service. If desired, for example, some content may be made private, so that it may be viewed by its creator only. Other content may be made more public, so that it may be accessed by all members of the service. Still other content may be made publicly available both to members and non-member users of the service.

Users of system 10 can communicate with one another using instant messaging, real-time chat, blogs, and other collaborative services.

Communications functions in the online service may be supported using any suitable protocols. For example, interactive communications sessions between members can be initiated using the Session Initiation Protocol (SIP). Protocols such as Voice Over Internet Protocol (VoIP) may be used to support audio communications. Audio may be encoded using the MP3 format or other suitable formats. Video (which includes audio) may be encoded using formats such as MPEG, QuickTime, and Windows Media. Using protocols such as these, members of the service can create links to other members and to topics of interest. Instant messaging communications may be sent between members. Members can chat about topics of mutual interest. Members can also create and edit blogs and access the blogs of the other members.

Shared media may be stored using media server 12. A web site may be associated with the service and with media server 12. Members may browse web pages on the web site or other user interface screens to locate content of interest. Each member may have a personal area on the server 12 and its associated web site. This personal area is sometimes referred to as a member's profile, a member's personal space, a member's area, a member's home page, or a member's personal screen. Each member profile contains content that the member has uploaded and edited. User profile data 19 may be stored in a database 14 on media server 12. Profile data 19 may include user names, favorite links, descriptive text, images, blog entries, etc. The service may also support community profiles (e.g., shared areas of the online service that are associated with online communities built around shared interests). Community profiles may be created as sub-profiles under a user's personal profile and are therefore sometimes referred to as sub-profiles, interest profiles, or topic profiles.

Users are typically required to log into the service before uploading content to their profiles. After logging in, a user can upload a media file. System 10 can handle media of any suitable type, such as audio, video (which includes audio), text, images (e.g., photographs, graphics, etc.), animation, or combinations of such media or other suitable media. The uploading of audio files such as songs is sometimes described herein as an example. This is, however, merely illustrative. Users can upload any suitable media files if desired.

A media file has attributes such as its name (i.e., its filename), its size, and its type (e.g., a “.mp3” file type). Media files may also have additional attributes that define items such as the genre of the music file (e.g., rock, classical, jazz, etc.), the song title (which need not be the same as the filename), the album title for the album to which a given song belongs, the year in which the song was released, the name of the record label associated with the song, the name of the artist associated with the song, etc. Media file attributes such as these are sometimes referred to as metadata. Metadata for audio files is often represented using ID3 tags (e.g., title, artist, album, etc.) that are embedded in the audio files themselves.

A user who desires to upload content may obtain the content to be uploaded using any suitable technique. For example, a user may create an audio file from an original recording (e.g., when a user is a band member) or may rip an audio file from a compact disc. Audio files such as songs ripped from compact discs may have original metadata from an original content owner source such as a record company. Users can also add metadata to audio files in the form of user-added tags. The user-added metadata may include, for example, user ratings, user tags, comments, etc. After the uploading user has uploaded the content, other users may add additional metadata.

Consider, as an example, a situation in which user A desires to upload an audio file to media server 12 over communications network 28. Media server 12 can store uploaded media files 16 in one or more databases 14. Media server 12 may also save associated metadata 18 and associated usage rules 20 in database 14. Metadata 18 may include the original metadata that was associated with the uploaded audio file (e.g., metadata that was created by a content owner such as an entity associated with publishing a compact disc), metadata that was added by the uploading user, and metadata that was added by other users.

Media server 12 can provide users with access to the uploaded media files. For example, a browsing user who is interested in listening to a particular song can use a media player to listen to the song as it is streamed from media server 12 to computing equipment 32 over communications network 28. The user may control the playback of the song using a media player that is presented to the user as part of a web page on a web site associated with media server 12. The media player may be, as an example, an interactive media player that is implemented using Macromedia Flash technology.

Uploaded content has associated usage rights. Media server 12 stores usage rules 20 that are associated with various media files in database 14. The usage rights information stored by media server 12 allows media server 12 to provide users of system 10 with media access while preserving the rights of content owners 27.

Some content owners (rights holders) allow unrestricted use of their media files. Files of this type can be downloaded and copied without restriction. Other content owners place restrictions on content usage that limit the way in which users can access the content. For example, a content owner might allow a song to be streamed over the internet while prohibiting the downloading of the song over the internet. Audio files can be streamed by sending data in real time to a media player implemented in the user's web browser from media server 12. A user can listen to an audio file that is made available in this way, but is not provided with access to a downloaded digital copy of the file. If desired, content owners can place restrictions on songs that are available for streaming (e.g., “streaming access permitted to anyone after 10 PM,” “user can stream content 100 times total”, “user can stream short audio clips only,” “user can stream for five days,” “user can stream for the month of August,” etc.). Usage rights may varying depending on a user's geographic location. For example, if a user's equipment is located in or otherwise associated with country A, streaming may be permitted, whereas if a user's equipment is located in or otherwise associated with country B, streaming may not be permitted.

Media server 12 uses digital rights management service 22 to identify uploaded media files. This allows media server 12 to ensure that appropriate usage rules 20 are stored in database 14 and ensures that usage rights are respected for all uploaded and shared content.

In a typical scenario, a user logs into the online service to upload an audio file. The media server 12 obtains the uploaded media file with its associated metadata. The media server 12 provides the uploaded media file to digital rights management service 22 over communications network 28. Digital rights management service 22 identifies the media file and, based on this identification, provides media server 12 with information on the usage rules 20 that are associated with the uploaded file. The media server 12 can then store the usage rules 20 in database 14 and can provide users with access to the content of the uploaded media file in accordance with the usage rules.

Any suitable technique may be used by digital rights management service 22 to identify media files and their associated usage rights. With one suitable arrangement, digital rights management service 22 identifies the media file using media fingerprinting techniques. A media file fingerprint checking engine 24 is used to process each uploaded media file. The media file fingerprint checking engine processes the media file to extract unique identifying information. This information is sometimes referred to as the “fingerprint” of the media file. In situations in which the uploaded media file is an audio file, the unique identifying information may be referred to as an audio fingerprint. Service 22 compares the audio fingerprint and other information (e.g., metadata tags) to information in the registry 26 during the identification process.

If the media file does not match any entries in registry 26, the media file can be considered to have unrestricted usage rights and the media server 12 can be informed accordingly. If a match between the media file and the information in registry 26 is located, the uploaded media file can be positively identified and the particular usage rules associated with the uploaded media file can be determined. Each entry in registry 26 is typically associated with a particular media file and its set of associated usage rights. The usage rights in the registry 26 are provided to digital rights management service 22 by content owners 27 (e.g., over communications network 28). After identifying the media file (e.g., by comparing its digital fingerprint, filename, file type, artist name, and other metadata to entries in registry 26), digital rights management service 22 can look up which usage rights are associated with the file in the registry 26 (optionally using information on a geographic location that is associated with the user's equipment) and can send all or some of this usage rights information to media server 12 for storage as usage rules 20.

The digital rights management service or other suitable entity associated with the online service may provide automatically-generated reports on media file usage to interested parties (e.g., content owners, the media server, uploading users, etc.). The reports may be provided on a regular basis (e.g., at a predetermined interval) or upon demand. The reports may include information that reflects how popular certain profiles and/or media have become. Popularity information may be gathered based on how many media files are uploaded by a particular user, how many media files are uploaded to a particular profile, media file upload or playback frequency, media file playback counts (number of plays), geographic and demographic trend information gleaned from playback data, etc. This information may be gathered by analyzing information involved in using registry 26 and/or based on other activities in the online service.

When the media server 12 presents audio files or other media to a user, the media server 12 has an opportunity to present related content (e.g., content that appears to be similar to the currently playing media file based on its metadata, content that appears to be related to information in a currently displayed profile, etc.). Related content selection engine 21 may be used to determine which content is to be displayed. For example, engine 21 may be used to determine which content is related to the currently playing media file and, if desired, which content is related to profile information such as profile information in a sub-profile containing the media file or a user profile that contains a sub-profile containing the media file. Related content may be obtained from related content media server 30. Suitable related content that may be displayed for a user includes targeted advertisements (e.g., an advertisement suggesting that a user click on an on-screen option to initiate a purchase transaction for a currently playing song), links to similar media files, links to profiles that are associated with a particular media file, etc. Related content may be displayed in a user's media player or elsewhere on a web page or other screen being displayed for the user by the user's web browser 34 or other client.

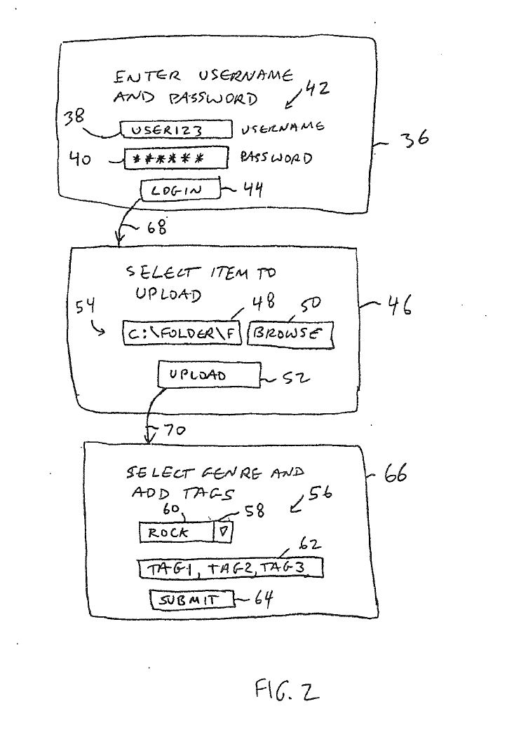

Illustrative screens that the service may present to a user during operations associated with logging into and using an online media sharing and communications service are shown in FIG. 2. Screen 36 of FIG. 2 is an illustrative logon screen. One or more screens such as screen 36 may be presented to the user by the online service to gather user login credentials. In the example of FIG. 2, the login credentials that are being gathered are username and password credentials. This is merely illustrative. Any suitable user credentials may be gathered when authenticating a user to the system (e.g., biometric credentials).

As shown in FIG. 2, a user can enter login credentials in user credential verification region 42. A username may be typed into username entry region 38. A corresponding user password may be typed into region 40. The password may be obscured (e.g., using a default character such as an asterisk) to enhance security. After the user has entered a username and password in region 42, the user may click on an on-screen option such as login button 44 to submit the credentials that were entered in region 42 to the online service (e.g., to media server 12, an authentication server associated with media server 12, or other suitable equipment in system 10).

As shown by arrow 68, following successful authentication of the user, the online service may provide the user with one or more media upload screens such as screen 46. A suitable media upload screen allows the user to select media files of interest to upload to media server 12 over communications network 28. Any suitable format may be used to identify which data is to be uploaded to server 12. In the example of FIG. 2, screen 46 contains a file selection region 54. By clicking on browse button 50 and navigating through the user's locally stored files and folders until a desired media file path is displayed in region 48, the user can identify a file of interest. The user may then click on upload button 52 to initiate the upload process.

The user may use an arrangement of the type shown in screen 46 to upload any desired media, including songs and other media files, videos, images, documents, etc. With one suitable arrangement, the user uses a region such as region 54 to upload an audio file such as a song and is then presented with another region such as region 54 with which the user is provided with an on-screen opportunity to upload a corresponding image (e.g., a digital photograph or graphic image that is to be associated with the uploaded audio file). Later, when a user is playing back the uploaded audio file in a media player, the uploaded image may be displayed in the media player or elsewhere on the user's display screen.

As shown by arrow 70, after the user clicks on upload button 52, the online service may present the user with a screen such as screen 66. Screens such as screen 66 may be used to allow users to add tags or other metadata to an uploaded media file. In general, any suitable user interface arrangement may be used to provide users with an opportunity to add or modify the metadata associated with a media file. In the example of screen 66, the user is provided with a metadata entry region 56 that includes a genre entry region 60 based on a drop-down menu and a tag entry region 62. The user may click on button 58 to select a desired genre tag to associate with the media file that is being uploaded. Illustrative genre choices that may be presented in the drop-down genre menu include rock, jazz, classical, hip-hop, etc. If the uploaded media file is a video, region 56 can present the user with genres appropriate for video content.

After selecting a genre, the user can type one or more tags into region 62. If more than one tag is entered, the user may separate the tags with a suitable separation character (e.g., commas). In the example of FIG. 2, the user has entered three tags, called tag1, tag2, and tag3.

A user may enter any suitable information as a tag. Tags are typically keywords or other words that a user associates with the particular media file. For example, if an uploaded song has a fast tempo, a user might enter the word “fast” as a tag. If a user likes the media file that is being uploaded, the user might enter the word “hot.” If the user associates the uploaded media file with a particular city, the user might enter the name of the city (e.g., “L.A.”). Because the user can enter any desired combination of characters in the tag entry region 62, the user is able to enter media genres and other metadata beyond the predefined genre categories presented with the genre drop-down menu.

After a user has selected a genre to be associated with the uploaded media file and has entered desired tags for the uploaded media file, the user may click on a button such as submit button 64. When the user selects button 64, the selected genre and user-defined tags are submitted to the media server 12 over communications network 28. Following identification using digital rights management service 22, the media server 12 stores the uploaded media file content 16, the uploaded associated metadata 18, and the associated usage rules obtained from registry 26 of digital rights management service 22 in database 14.

Users may submit profile information such as links to sub-profiles, descriptive text, blog entries, cover art and other images, and links to favorite sites to media server 12. Metadata associated with a media file may be submitted to media server 12 by the user who is uploading the media file and by other users of the online service. The online service may present users with screens in which uploaded metadata from multiple sources is displayed. At the same time, the online service may present the user with related content. The related content may be selected based on profile information and metadata that has been uploaded from multiple sources (e.g., an uploading user, other users, an original content owner, etc.).

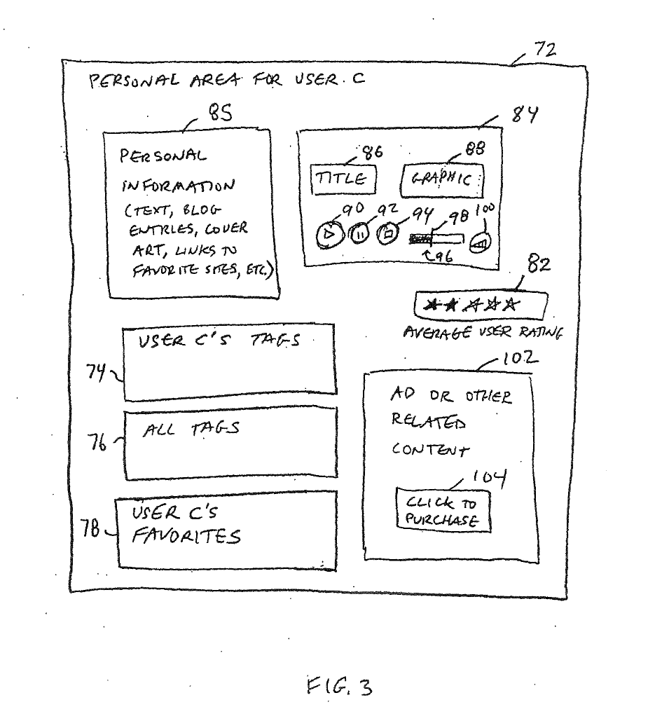

An example is shown in FIG. 3. In the example of FIG. 3, a user has logged into the online service and has browsed to a web page or other suitable screen 72 that is associated with a personal profile for user C of FIG. 1. As shown in FIG. 3, personal profile screen 72 may include personal information 85 such as links to sub-profiles, descriptive text, blog entries, cover art and other images, and links to favorite sites. Screen 72 also contains a media player 84 that is being used to present an audio file to the user. In general, a media player may present any suitable information to the user as part of a media file playback experience. In the example of FIG. 3, media player 84 is being used to play back a song to the user. During presentation of the song, digital audio data for the song is streamed to the user's computing equipment 32 from the media server 12 over communications network 28. The streamed digital audio data is converted into sound for the user by the user's media player software, which may be implemented using client software (e.g., a web browser 34) on the user's computing equipment 32.

From a digital rights management perspective, it can be advantageous to stream media files to users rather than allowing users to download media files. During the streaming process, a user is able to enjoy the streamed content, but is not able to access a downloaded copy of the media file. A streamed media file may be briefly stored on a user's equipment in a hidden cache during the streaming process, but the contents of this cache are not user-accessible because access is prohibited by the user's media player and/or the user's operating system. Streamed content is therefore secured against unauthorized copies, which helps ensure that the interests of artists and other content owners are protected.

As the song is being played for the user, the song's title 86 may be displayed by the media player 84. A graphic 88 that is associated with the song may also be displayed. The graphic may be, as an example, a graphic that a user uploaded using an upload screen such as screen 46 of FIG. 2. Media player 84 may include interactive control buttons such as play button 90, pause button 92, stop button 94, and volume button 100. The current status of the media being played back may be indicated using status bar 96. A status indicator 98 on bar 96 can be used to show how much of a song has been streamed to the user.

Screen 72 may include metadata such as tags. Tags that were added by the uploading user (user C in this example) may be displayed in tag region 74. Tags that have been added by other users may be displayed in tag region 76. Links to related content of interest (e.g., links that have been defined by user C) may be displayed in region 78 or in personal profile information region 85. Regions such as regions 78 and 85 may also be used to display profile information such as media file descriptions, blog entries, cover art, etc. A user may edit a profile to add links of interest and other profile information using a profile edit screen displayed on user computing equipment 32 using web browser 34 (as an example). The profile edit screen may also be used to create and edit sub-profiles.

Information on user ratings and other user-generated content can be displayed on screens such as screen 72. In the example of FIG. 3, screen 72 contains a region 82 that is used to display an average star rating for the song being presented by media player 84. The star rating that is represented in region 82 is a form of user-generated metadata that is associated with the song and that may be stored by media server 12 in database 14.

Content that is related to the media file that is currently being presented to the user can be provided to the user in one or more related content regions such as related content region 102. Related content selection engine 21 (FIG. 1) can be used to determine which related content is to be displayed in regions such as region 102. Related content selection engine 21 may make its content selection determinations based on any suitable input. With one suitable arrangement, related content is selected based on user profile information (e.g., personal information of the type displayed in region 85 of FIG. 3), sub-profile information (e.g., information on a topic profile screen being used to promote a band and containing a media player 84 that is playing the band's songs to users), and metadata associated with played back media files (such as the band's songs).

In the example of FIG. 3, the related content region 102 is interactive and contains a user-selectable button 104. The user can click on button 104 to purchase a product or service being advertised in region 102. As an example, consider the situation in which a popular song is being played by media player 84. As the song is being played, an advertisement for an album containing the song may be displayed in region 102. A user who is interested in purchasing the album may click on click-to-purchase option 104.

Related content that is displayed in regions such as related content region 102 of FIG. 3 may be obtained from a related content media server such as related content media server 30 of FIG. 1 using related content selection engine 21. If desired, the functions of server 30 may be implemented on the same hardware platform as media server 12. The operations of servers 12 and 30 may also be combined into a single server or may be distributed among three or more servers.

With one particularly suitable arrangement, the online service determines which content is related to the currently-playing song based on which metadata is associated with the currently-playing song. For example, the online service may use engine 21 to locate related content of interest based on the title shown in region 86, the filename of the uploaded media file (which may or may not be the same as title 86), the tags or parts of the tags presented in regions 74 and 76, metadata associated with the media file for the currently-playing song such as the genre tag that an uploading user assigned to the song using a drop-down menu of screen 66 of FIG. 2, other ID3 metadata such as artist name (e.g., original metadata tags that were associated with a media file by a content owner), etc. Related content may also be selected based on other data available to the online service such as data on which links are associated with the web page being used to play back the currently-playing song, user profile and sub-profile information, etc.

Sub-profile areas in the online service are generally associated with online communities rather than individuals. As an example, a community sub-profile web page may be associated with a rock band. The community web page may contain content that a representative of the rock band has submitted to the online service and contributions from fans. A given user may create multiple associated community profiles, thereby providing a rich and varied environment for communicating and collaborating with other users. This rich environment adds value to the online service and furthers the interests of the content owners who are interested in promoting their content.

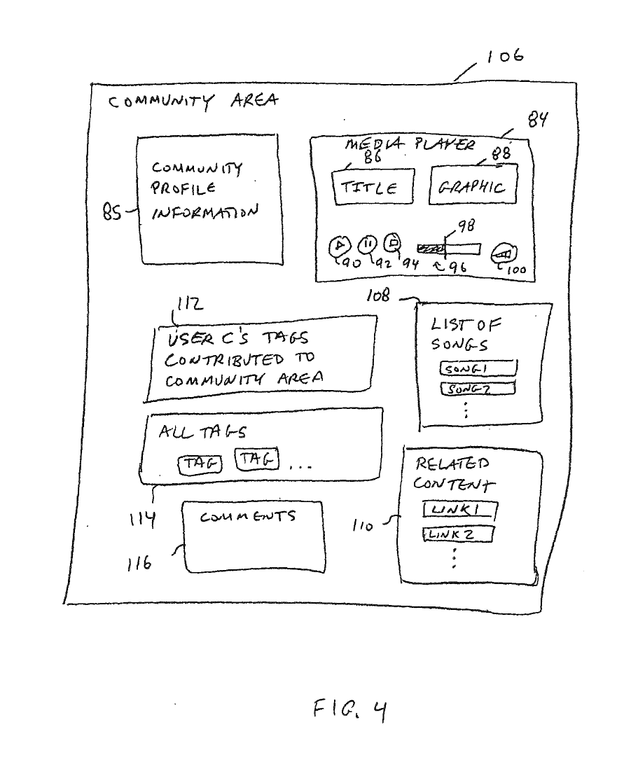

An illustrative community profile screen 106 that may be created by a user is shown in FIG. 4. In general, community screens may contain any suitable information such as text, graphics, audio, video, etc. In the example of FIG. 4, screen 106 contains a media player 84 that is being used to present a song to a user. Audio data for the song is being streamed to the user over network 28 while information for the song such as the song's title 86 is displayed in the media player 84. Community profile information 85 may include media file descriptions, blog entries, cover art, links to web sites, etc.

A playlist or other suitable list of songs may be displayed in a region such as playlist region 108. Songs may be listed in region 108 in order of their expected presentation to the user. For example, the currently playing song may be listed at the top of list 108, the next song to be played may be listed just below the currently-playing song in list 108, etc.

Content that is related to the currently-playing song may be displayed in one or more related content regions such as region 110. Region 110 may use a format that is the same as or similar to the format used for region 102 of FIG. 3. In the example of FIG. 4, related content region 110 contains links to web pages that are related to the currently-playing song. If desired, targeted advertisements may be displayed in region 110. Permanent links may also be included in screen 106 (e.g., links to other web pages in the web site associated with the online service, links to external web pages, etc.). Metadata that is associated with the currently-playing song may be displayed in regions such as tag regions 112 and 114.

In the example of FIG. 4, a particular user (user C) has contributed the tags displayed in region 112. Other users have contributed the tags of region 114. When user C views screen 106, the online service segregates user C's tags in a separate region 112, so that user C can view those tags separately from the tags of other users that are being displayed in region 114.

If desired, user-supplied comments may be presented in a comment region 116 on the screen or in region 85. The comments may be, for example, comments that are displayed in real time (chat) or time-insensitive comments (posts). The comments may relate to the currently-playing song, the content of the screen 106, etc. Comment regions such as comment region 116 may be displayed on community profile screens and user profile screens.

The tags of regions 112 and 114 and any other information related to the currently-playing song and the currently-displayed web page (e.g., the text of comments in comment region 116) may be used in selecting which targeted advertisements and other related content to present to the user.

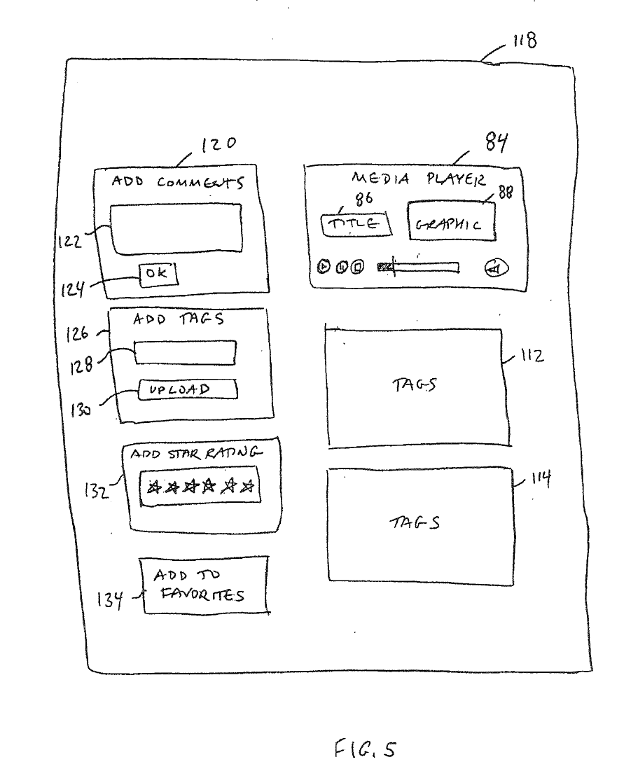

Any suitable user interface arrangement may be used to supply comments and other profile information and tags and other metadata to the online service. An illustrative screen 118 that a user may use to supply profile information and metadata related to uploaded media files is shown in FIG. 5. As shown in FIG. 5, screen 118 may include a media player 84. The title 86 of a currently-playing song or other media file and an associated graphic 88 (e.g., a user-supplied graphic) may be presented by the media player.

In the example of FIG. 5, screen 118 contains an add comments region 120. The user can type comments into region 122 and can click OK button 124 to upload comments. The uploaded comments may be, for example, comments on a song that is currently playing in the user's media player 84. The comments may also be comments that are related to a particular community profile page, user profile page, etc. Comments may be displayed using a comment region such as comments region 116 of FIG. 4.

Tags associated with the currently-playing media file can be displayed on screen 118 (e.g., in regions 112 and 114). The user may modify tags and other metadata using suitable on-screen options. For example, screen 118 may have an add tags region 126. A user can add a tag to the tags that are already associated with the audio file that is currently playing in media player 84. The user can type text for tags into region 128. When more than one tag is being supplied, the user can separate the tags with commas or other suitable separators. The user can then click on upload button 130 to upload the tags to the media server 12 over network 28. The media server receives the tags and stores them as user-supplied metadata in database 14.

User rating information such as a user star rating can be uploaded to the media server 12 using a user rating region such as add star rating region 132. Star rating region 132 contains a number of clickable stars. The user can click on an appropriate star to upload a corresponding star rating to the media server 12. If, for example, the user clicks on the first (leftmost) star in region 132, a one-star rating will be uploaded. If, on the other hand, the user clicks on the third star (third from the left) in region 132, a three-star rating will be provided to server 12.

Add to favorites option 134 can be selected when a user desires to add a currently-playing audio file to the user's list of favorite songs. Information on the user's favorites and other user-specific information may be stored in a user settings database maintained by system 10 (e.g., a database such as database 14 of FIG. 1, a database on a global server associated with the service, etc.). User-defined favorites may be displayed in a list (e.g., in a list of a user's favorite links such as favorites list 78 of FIG. 3).

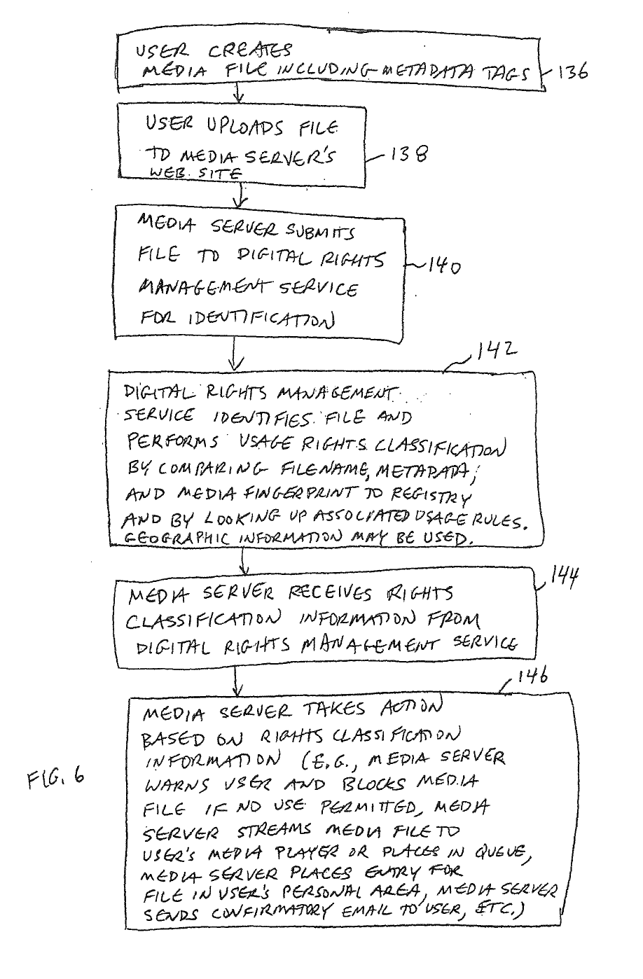

Illustrative steps involved in uploading content to the online service while using rights classification information to ensure that the usage rights of uploaded content are respected are shown in FIG. 6.

At step 136, a user of the service obtains a media file to upload. The user may create the media file using media capture tools (e.g., sound or video recording tools), by receiving the media file electronically (e.g., as a download or as an email attachment), by copying the media file from a storage medium (e.g., a compact disc), or by otherwise obtaining the desired media file. The media file will generally have associated metadata. For example, an audio file such as a song will typically have associated ID3 metadata tags.

At step 138, the user logs into the online service (if the user has not already done so) and uploads the media file to media server 12 over communications network 28. During the uploading operations of step 138, the user may add genre information, user-defined tags, and other metadata, as described in connection with the example of FIG. 2. Other users of the system can also add tags and other metadata, as described in connection with FIG. 5.

At step 140, the media server 12 receives the uploaded media file from the user's computing equipment 32. The media server 12 submits the uploaded media file to digital rights management service 22 for identification.

At step 142, the digital rights management service 22 receives the media file from the media server. The digital rights management service 22 identifies the media file by comparing attributes of the media file to information stored in registry 26. With one suitable arrangement, digital rights management service 22 uses media file fingerprint checking engine 24 to compute a media file fingerprint for the uploaded file that is compared to stored fingerprint data in registry 26. The digital rights management service 32 can also identify the uploaded file using metadata information such as title, artist, and genre information, by inspecting the filename or file extension of the uploaded file, etc. If desired, the digital rights management service 22 may obtain information on which geographic location is associated with the user's computing equipment. This location information may be used by the digital rights management service during step 142 to identify appropriate location-sensitive usage rights information to be applied to the media file.

If the uploaded media file cannot be identified by comparison of its attributes to known media file information such as the information maintained in registry 26, it can be assumed that the uploaded media file is not restricted. It will therefore be permissible to use the uploaded media file by streaming the uploaded media file to the media players of interested users. If, however, the uploaded media file can be identified, the digital rights management service 22 can use usage rights information stored in registry 26 to determine which predefined usage rules apply to the media file. Information on the identity of the media file (i.e., whether the file was identified or not and, if identified, its identity) and the corresponding usage rules for the file (i.e., whether or not the file is restricted and, if restricted, which owner-defined usage rules apply) may be conveyed to the media server 12 over communications network 28. The media server 12 receives usage rights classification information such as the identity of the media file and its usage rules from digital rights management service 22 at step 144.

At step 146, the media server 12 takes appropriate action based on the usage rights classification information that has been received from the digital rights management service. For example, media files that are not positively identified by comparison to information associated with the registry 26 may be assumed to be unrestricted. Media files of this type may be streamed to users of the online service, who receive and play the media files using media player 84 (FIGS. 3-5). As another example, if a media file is identified as having a streaming only after 10:00 PM usage rule, the media server 12 can determine whether or not it is after 10:00 PM before streaming the media file to a requesting user.

Whenever it is determined that the usage rights for an uploaded media file do not allow the media file to be used by the service (e.g., because the file is identified as a blocked file or is identified as having usage rules that do not permit streaming of content), appropriate users (e.g., the uploading user) can be warned using a suitable on-screen warning. The uploaded media file may then be deleted or otherwise blocked. If desired, the media server 12 may create a placeholder link for the blocked media file. If, at a later date, content owners 27 update the usage rights information stored in registry 26 of digital rights management service 22 so that access is permitted, the media server can unblock the previously blocked media file. Once the placeholder is activated, the media file appears as an uploaded file on the online service (e.g., on a suitable profile screen).

The online service may communicate with the uploading users and other users by sending email messages or other suitable notifications. For example, when an uploaded file has successfully passed the rights classification tests performed by digital management service and has been placed on a suitable profile screen, the media server 12 may send the user a confirmatory email that notifies the user that the file has been identified and accepted.

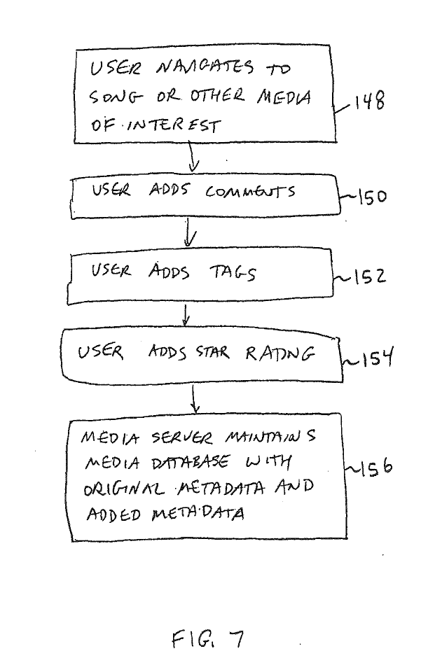

As described in connection with FIG. 5, users who are not necessarily the uploading user may add metadata to the uploaded file in the form of tags, comments, star ratings, etc. Illustrative steps involved in adding metadata to an uploaded file are shown in FIG. 7.

At step 148, a user uses a web browser 34 or other client to navigate to a song or other uploaded media file of interest. The user may, for example, use browser forward and back buttons or other browser-based or browser-like navigation buttons to locate a web page of interest on a web site maintained by media server 12. The user may also click on links such as the links in region 110 of FIG. 4. If desired, items such as the songs listed in the playlist 108 of FIG. 4 and the tags of regions 112 and 114 may also be provided in the form of interactive links.

After locating a media file of interest, the media file may be played back to the user (e.g., using a media player 84 of the type shown in FIG. 5). The user can add comments and other profile information that relate to the currently-playing media file using a comments region such as add comments region 120 of FIG. 5 (step 150). An add tags region such as add tags region 126 may be used by the user to add tags to the currently-playing song (step 152). The user may click on a star in add star rating region 132 to contribute a star rating to the currently-playing song (step 154). As shown by step 156 of FIG. 7, the media server 12, which receives the user-supplied comments, tags, star ratings, and other suitable metadata for the media file, maintains the user-supplied metadata in media database 14. The media server 12 maintains the original metadata (e.g., the metadata that was originally created by a content owner and embedded on a compact disc), metadata from the uploading user (e.g., genre and other tag information), and metadata from other users (e.g., tags).

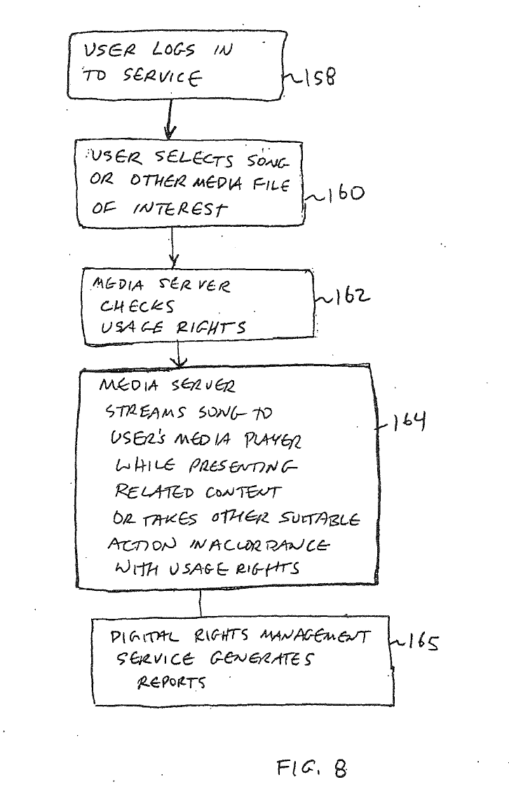

Illustrative steps involved when a user logs into the online service to obtain access to an uploaded media file are shown in FIG. 8.

At step 158, a user may log into the online service (e.g., using a login screen such as login screen 36 of FIG. 2).

At step 160, the user selects a song or other media file of interest. The user may, for example, navigate to a personal profile page or a community profile page or may click on a link to a song.

As shown by step 162, before media server 12 streams media files over network 28, the media server 162 checks usage rules 20 to determine whether the desired presentation is permissible. If, for example, playback of an uploaded song is desired, the media server 12 checks rules 20 to determine the circumstances under which streaming is permitted.

If it is determined at step 162 that streaming is permitted, the media server 12 streams the media file to the user in accordance with the usage rights for the media file at step 164. If desired, media playback may be made contingent on the viewing user having a certain subscription level with the online service. The streamed media file may be presented to the user using a media player 84. While the media file is being played, related content such as a targeted advertisement may be presented to the user (e.g., using a related content region such as region 102 of FIG. 3 or region 110 of FIG. 4). Related content such as a targeted advertisement may also be presented to the user just before or just after the media file is played (e.g., using related content region 102 or 110 or using the media player 84). Selection of the related content may be made by related content selection engine 21 based on profile information associated with the media file and based on the metadata associated with the media file (e.g., the tags of the uploading user and other users, comments and ratings supplied by users, original tags such as ID3 tags that were created by a content owner, etc.).

As shown by step 165, the digital rights management service or other suitable equipment in system 10 may generate reports on media file usage for interested parties (e.g., content owners 27, users, the media server, etc.). The reports may cover information on how popular certain aspects of the online service have become (e.g., profile popularity, user popularity, media file popularities, etc.). Popularity information may be gathered based on how many media files are uploaded by a particular user, how many media files are uploaded to a particular profile, media file upload or playback frequency, media file playback counts (number of plays), geographic and demographic trend information gleaned from playback data, or any other suitable data associated with the online service. This information may be gathered by analyzing information involved in using registry 26 and/or based on other activities in the online service.

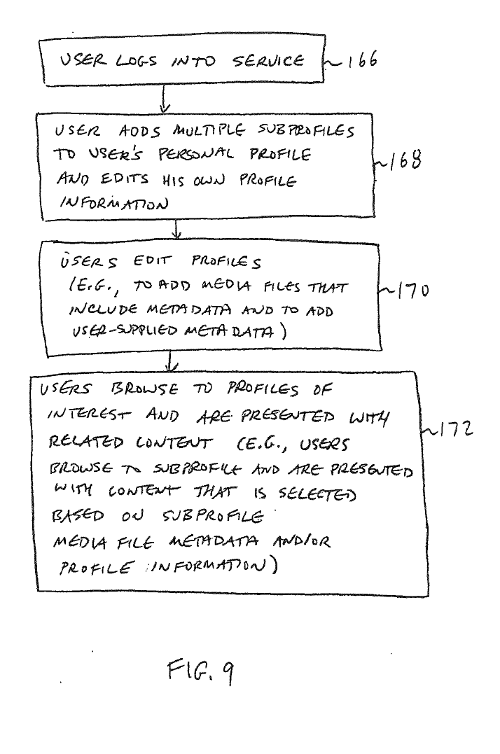

The online service provides an attractive environment for users by allowing users to create highly customized profiles. Illustrative steps involved in editing profiles on the online service are shown in FIG. 9.

As shown by step 166, users may be required to log into the online service before making certain types of changes to online content. For example, users may be required to log on to the service before creating or deleting a profile. If desired, users may make certain contributions without logging on to the service. Alternatively, all users may be required to log on to the service before making contributions.

At step 168, a user uses one or more profile creation or editing screens to generate and edit sub-profiles that are associated with the user's personal profile. In a typical scenario, sub-profiles are associated with particular artists or areas of interest.

At step 170, users can edit profiles that have been created. For example, users can upload media files of interest to profile screens for streaming to other users. The uploaded media files may contain original metadata and metadata contributed by the uploading users and by other users. Users can add tags and other metadata and can add profile information such as blog entries, links, etc.

At step 172, users can navigate to profiles of interest using browser navigation buttons or other suitable user interface controls. Users may, as an example, navigate to a profile screen that contains a media player that is playing a media file of interest. As the media file is being streamed to one or more users, related content may be presented. The related content may include targeted advertisements that generate revenue for the online service.

Related content selection engine 21 may select which content is “related” based on profile information and metadata associated with the currently playing media file. If the media file is playing in a sub-profile screen, for example, the related content may be selected based on profile information associated at least partly with the sub-profile. Profile information that is associated with the user profile of the user who created the sub-profile may also be used in determining which related content to display. If desired, user personal profile information may be given less weight than the profile information associated with the sub-profile or other suitable weighting schemes may be used.

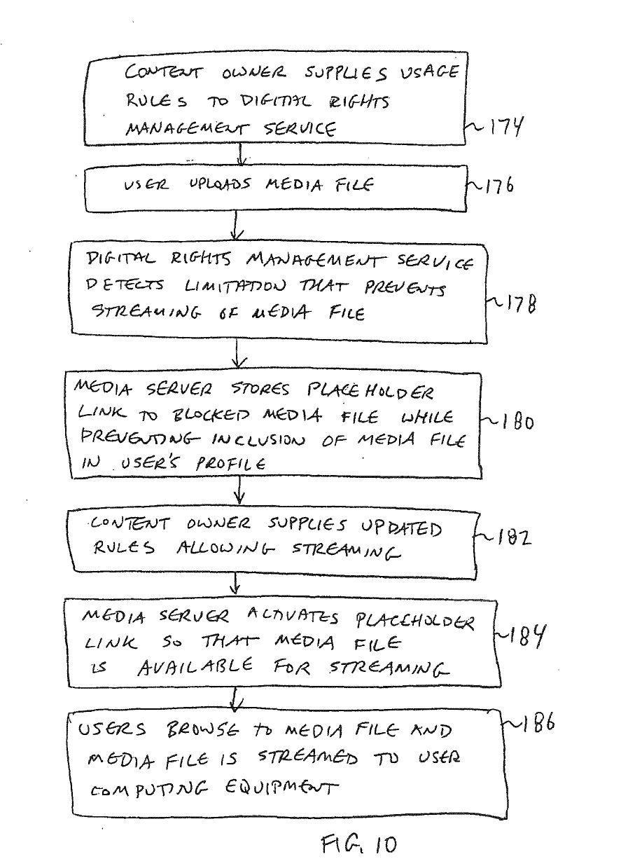

The online service allows content owners to adjust media usage rights at any suitable time. Illustrative steps involved in using the online service in a situation in which a content owner desires to update usage rights information for a media file are shown in FIG. 10.

At step 174, a content owner supplies usage rights information for a particular media file to digital rights management service 22. The content owner can supply usage rights information using any suitable arrangement. For example, a content owner can electronically convey usage rules to service 22 over communications network 28. Digital rights management service 22 stores the usage rights information in registry 26.

At step 176, a user who has created or otherwise obtained a media file uploads the media file to the media server 12 over network 28. The user may use an upload arrangement of the type described in connection with FIG. 2 or any other suitable arrangement. The media server 12 provides the uploaded media file to digital rights management service 22 for identification.

At step 178, the digital rights management service 22 uses the media file fingerprint checking engine 24 and registry 26 to determine whether or not it is permissible for media server 12 to stream the uploaded media file to users. In the present example, the usage rules that were provided to the digital rights management service 22 at step 174 by content owners 27 include a limitation that prevents the media server 12 from streaming the media file to users. The digital rights management service 22 detects this limitation and informs media server 12 accordingly.

At step 180, the media server 12 blocks the uploaded media file so that the uploaded media file is not available for streaming to users. Any suitable blocking technique may be used. With one suitable arrangement, the media server 12 blocks the uploaded media file by declining to include the media file on the profile screen to which the user was uploading. To allow for potential unblocking of the blocked media file in the future, the media server 12 can store a placeholder link in database 14. The placeholder link is not visible to users of the online service, but serves to memorialize the location at which the uploaded file was to have been displayed.

In the example of FIG. 10, the content owner revises the usage rights that apply to the blocked media file. The revised usage rights permit streaming. At step 182, the content owner 27 supplies the updated usage rights information to the digital rights management service 22. The digital rights management service 22 updates the registry 26 to reflect the new version of the usage rules.

The digital rights management service 22 informs the media server 12 that the usage rights for the media file have been updated. If desired, the media server 12 can request updates from digital rights management service 22. After becoming aware that the revised usage rights for the media file allow the media file to be streamed to users, the media server 12 can activate the placeholder. Any suitable activation technique may be used. With one illustrative arrangement, server 12 activates the placeholder by adding the media file to the profile page to which the user had originally uploaded the file (step 184). Activating the placeholder in this way serves to make the media file available for streaming to users of the online service.

At step 186, users can navigate to the media file. The media server 12 can stream the media file to users over communications network 28. Users are presented with the media file using media players implemented on user equipment 32.

The foregoing is merely illustrative of the principles of this invention and various modifications can be made by those skilled in the art without departing from the scope and spirit of the invention.

What is claimed is:

1. A method for supporting an online media file sharing service in which users at computing equipment communicate with a media server over a communications network, the method comprising:
at a given user's computing equipment, uploading a media file to the media server;
at the media server, submitting the media file to a digital rights management service over the communications network;
at the digital rights management service, using a media file fingerprint checking engine to generate a fingerprint of the media file;
at the digital rights management service, identifying which usage rules apply to the media file by comparing at least the fingerprint of the media file to a registry, wherein the identifying comprises:
determining that the fingerprint does not match a fingerprint in the registry;
based on the determining, determining that the media file is unrestricted;
at the media server, receiving the usage rules that have been identified by the digital rights management service over the communications network; and
if permitted by the usage rules, streaming the media file to the computing equipment of at least one of the users from the media server over the communications network.

2. The method defined in claim 1 wherein the communications network comprises the internet and wherein the media file comprises an audio file, the method further comprising streaming the audio file to a media player on the user's computing equipment in real time over the internet.

3. The method defined in claim 1 further comprising displaying an on-screen option on the computing equipment of the given user that allows the given user to associate a tag with the media file that is uploaded to the media server by the given user.

4. The method defined in claim 1 further comprising displaying an on-screen option on the computing equipment of another user that allows that user to associate a tag with the media file that was uploaded to the media server by the given user.

5. The method defined in claim 1 further comprising displaying an on-screen option on the computing equipment of another user that allows that user to associate a comment with the media file that was uploaded to the media server by the given user.

6. The method defined in claim 1 further comprising:
with the media server, maintaining a database of uploaded media file content, associated metadata, and associated usage rules.

7. The method defined in claim 1, wherein streaming the media file to the user's computing equipment over the communications network comprises streaming the media file to a media player that is displayed on a screen on the user's computing equipment, the method further comprising:
displaying related content on the screen while the media player is playing the media file to the user.

8. The method defined in claim 1, wherein streaming the media file to the user's computing equipment over the communications network comprises streaming the media file to a media player that is displayed on a screen on the user's computing equipment, the method further comprising:
displaying related content on the screen the media player plays the media file to the user, wherein the displaying forces the user to view the related content before obtaining access to the media file.

9. The method defined in claim 1, wherein the media file has associated metadata and wherein streaming the media file to the user's computing equipment over the communications network comprises streaming the media file to a media player that is displayed on a screen on the user's computing equipment, the method further comprising:
when the media player is playing the media file to the user, identifying content that is related to the media file based on the metadata that is associated with the media file.

10. The method defined in claim 1, wherein the media file is associated with profile information and wherein streaming the media file to the user's computing equipment over the communications network comprises streaming the media file to a media player that is displayed on a screen on the user's computing equipment, the method further comprising:
when the media player is playing the media file to the user, identifying content that is related to the media file based on the profile information that is associated with the media file.

11. The method defined in claim 1, wherein the media file has associated metadata including user-defined tags and wherein streaming the media file to the user's computing equipment over the communications network comprises streaming the media file to a media player that is displayed on a screen on the user's computing equipment, the method further comprising:
when the media player is playing the media file to the user, identifying content that is related to the media file based on the user-defined tags that are associated with the media file; and
displaying the related content that has been identified on the screen while the media player is playing the media file to the user.

12. The method defined in claim 1 further comprising:
with the given user's computing equipment, providing the media server with first metadata tags that are associated with media file;
with the computing equipment associated with another user, providing the media server with second metadata tags that are associated with the media file; and
with the media server, maintaining a database containing the uploaded media file and the first and second associated metadata tags.

13. The method defined in claim 1 wherein identifying which usage rules apply to the media file comprises comparing information on a geographic location associated with the given user's computing equipment to the registry to determine which geographic limitations are associated with the usage rules.

14. The method defined in claim 1 further comprising using the digital rights management service to automatically generate reports on media file usage.

15. The method defined in claim 1, wherein streaming the media file to the user's computing equipment over the communications network comprises streaming the media file to a media player that is displayed on a screen on the user's computing equipment, the method further comprising:
with the given user's computing equipment, providing the media server with first metadata tags that are associated with media file;
with the computing equipment associated with another user, providing the media server with second metadata tags that are associated with the media file;
with the media server, maintaining a database containing the uploaded media file and the first and second metadata tags;
when the media player is playing the media file to the user, identifying content that is related to the media file based on the first and second metadata tags that are associated with the media file; and
displaying the related content that has been identified on the screen while the media player is playing the media file to the user.

16. The method defined in claim 1, wherein the media file has associated metadata including user-defined tags and wherein streaming the media file to the user's computing equipment over the communications network comprises streaming the media file to a media player that is displayed on a screen on the user's computing equipment, the method further comprising:
with the given user's computing equipment, providing the media server with first metadata tags that are associated with media file;
with the computing equipment associated with another user, providing the media server with second metadata tags that are associated with the media file;
with the media server, maintaining a database containing the uploaded media file and the first and second metadata tags, wherein the communications network comprises the internet, wherein the media file comprises an audio file, and wherein streaming the media file comprises streaming the audio file to a media player on the user's computing equipment in real time over the internet;
when the audio file is being streamed to the media player, identifying content that is related to the media file based on the first and second metadata tags that are associated with the media file; and
displaying the related content that has been identified on the screen while the media player is playing the media file.

17. A method for supporting an online audio file sharing service in which users at computing equipment communicate with a media server over the internet, the method comprising:
at a given user's computing equipment, uploading an audio file to the media server, wherein the audio file contains original metadata including a song title;
at the media server, submitting the audio file to a digital rights management service over the communications network;
at the digital rights management service, using an audio file fingerprint checking engine to generate an audio file fingerprint of the audio file;
at the digital rights management service identifying which usage rules apply to the audio file by comparing at least the audio file fingerprint to a registry maintained at the digital rights management service wherein the identifying comprises:
determining that the audio file fingerprint does not match a registry audio file fingerprint in the registry;
based on the determining, determining that the media file is unrestricted;
at the media server, receiving the usage rules for the audio file that have been identified by the digital rights management service over the internet;
with the given user's computing equipment, providing the media server with first metadata tags that the given user has associated with the audio file;
with the computing equipment associated with another user, providing the media server with second metadata tags which that user has associated with the audio file;
with the media server, maintaining a database containing the uploaded audio file from the given user, the usage rules that have been identified as applying to the audio file, and the first and second metadata tags;
at the media server, determining from the usage rules whether it is permissible to stream the audio file to a media player on computing equipment associated with one of the users;
if it is determined from the usage rules that it is not permissible to stream the audio file, blocking the audio file from being streamed; and
if it is determined from the usage rules that it is permissible to stream the audio file, streaming the audio file to the media player of that one of the users over the internet in real time.

18. The method defined in claim 19 further comprising:
when the audio file is being streamed to the media player, identifying content that is related to the audio file based on the first and second metadata tags that are associated with the media file.

19. The method defined in claim 19 further comprising:
when the audio file is being streamed to the media player, identifying content that is related to the audio file based on the first and second metadata tags that are associated with the audio file and based on the original metadata.

20. The method defined in claim 19 wherein blocking the audio file from being streamed comprises storing a placeholder link at the media server, the method further comprising:
at the digital rights management service, updating the registry to reflect revised usage rules from a content owner that apply to the audio file, wherein the revise usage rules permit streaming; and
in response to the revised usage rules, activating the placeholder link at the media server and streaming the audio file to the media player of one of the users over the internet.
